(19) United States
(12) Patent Application Publication
(10) Pub. No.: US 2009/0162751 A1
(43) Pub. Date: Jun. 25, 2009

(54) LITHIUM ION SECONDARY BATTERY

(75) Inventors: Hidetoshi HONBO, Hitachinaka (JP); Akihide Tanaka, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Vehicle Energy, Ltd.

(21) Appl. No.: 12/342,146

(22) Filed: Dec. 23, 2008

(30) Foreign Application Priority Data
Dec. 25, 2007 (JP) 2007-331317

(51) Int. Cl. H01M 4/58; H01M 4/00

(52) U.S. Cl. 429/223; 429/231.95; 429/231.8

(57) ABSTRACT

A lithium secondary battery having high power characteristics and excellent life characteristics in which the anode comprises at least carbon as an anode active material, and an SBR latex and a cellulosic viscosity improver as a binder material, the carbon material has an inter layer distance (d₀₀₂) of from 0.345 to 0.37 nm and an intrinsic viscosity (ρ) of from 1.7 to 2.1 g/cc, and the weight ratio (R) of the cathode active material and the anode active material per unit area is within a range from 1.3 to 1.7.

### BACKGROUND OF THE INVENTION

1. Field of the Invention

The present invention relates to a lithium ion secondary battery.

2. Description of the Related Art

Since lithium ion batteries have high energy density and high power density, they have been used in recent years generally as power sources for personal computers and portable equipment. Further, along with development of electric cars and hybrid cars as environment-friendly cars, studies have been made on the lithium ion batteries for application to power sources for automobiles. In the application for electric cars and hybrid cars, high power, high energy density, and long life are important.

JP-A-2007-42571 discloses the use of carbon of low crystallinity with an inter layer distance (d₀₀₂) of 0.34 to 0.37 nm as an anode, a styrene-butadiene copolymer rubber (SBR) as an organic binder, and carboxymethyl cellulose as a viscosity improver.

However, since the battery life characteristics greatly vary depending on the combination of a cathode and an anode, it is difficult to attain a long life lithium ion battery based on the disclosed technique.

### SUMMARY OF THE INVENTION

The present invention intends to provide a lithium ion battery of high power and long life.

The present invention provides a lithium ion secondary battery in which a cathode for intercalating and deintercalating lithium ions and an anode for intercalating and deintercalating lithium ions are formed by way of an electrolyte and a separator. The cathode has a cathode active material and a binder, and an anode has an anode active material and a binder. The anode active material contains at least a carbon material. The binder comprises a styrene-butadiene copolymer rubber (SBR) latex and a cellulosic viscosity improver. The inter layer distance (d₀₀₂) of the carbon material is 0.345 nm or more and 0.370 nm or less, the intrinsic density (ρ) is 1.7 g/cc or more and 2.1 g/cc or less and the weight ratio for the amount of the cathode active material per unit area contained in the cathode to the amount of the anode active material per unit area contained in the anode is 1.3 or more and 1.7 or less.

According to the invention, a lithium ion battery having a high power and excellent life characteristics can be provided.

### BRIEF DESCRIPTION OF THE DRAWINGS

Other objects and advantages of the invention will become apparent from the following description of embodiments with reference to the accompanying drawings in which:

FIG. 1 is a view showing a lithium ion battery of the invention;

FIG. 2 is a graph showing the change of potential on the cathode and the anode in the initial cycle;

FIG. 3 is a graph showing the change of resistance of the anode of a lithium ion battery according to the invention; and

FIG. 4 is a graph showing the change of potential on the cathode and the anode of a lithium ion battery of Example 19.

### DESCRIPTION OF THE PREFERRED EMBODIMENTS

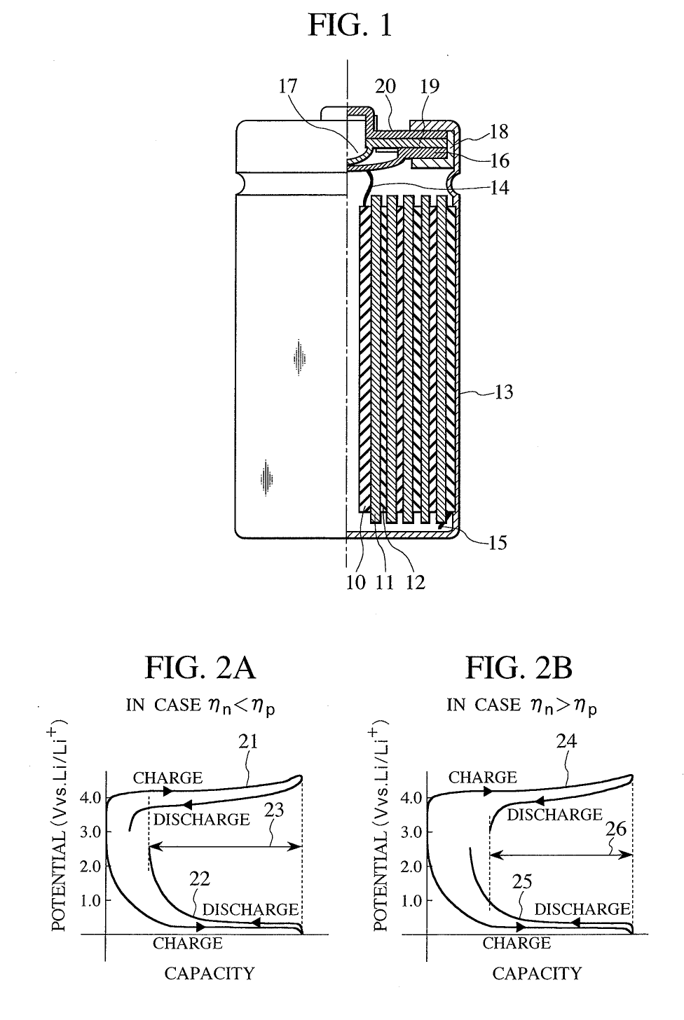

FIG. 1 is a schematic view of a lithium ion battery of the invention. In FIG. 1 are shown a cathode 10, a separator 11, an anode 12, a battery casing 13, a cathode tab 14, an anode tab 15, an inner lid 16, an inner pressure release valve 17, a gasket 18, a PTC device 19, and a battery lid 20.

The anode is formed by coating an anode material on a current collector comprising copper. For the anode material, a carbon material having an inter layer distance (d₀₀₂) of 0.345 to 0.370 nm, and an intrinsic density (ρ) of 1.7 to 2.1 g/cc is used as the anode active material. It is preferable that the carbon material have an average grain size of 20 μm or less and a specific surface area of 10 m²/g or less for preparing a stable anode mix and coating a smooth electrode in view of manufacture of the electrode.

As the binder material, it is preferable to use an SBR latex of excellent binding force and add a cellulosic viscosity improver. This can decrease the amount of the binder material to be used and can increase the ratio of the anode active material that contributes to charge/discharge capacity.

Further, since side-reaction tends to occur at the anode in the process of a charge/discharge cycle, it is necessary to set a charge/discharge operation range causing less side reaction, that is, an appropriate range for the state of charge. Since lithium ions are supplied from the cathode to the anode in the charging process, an appropriate range for the state of charge of the anode can be set by defining the amount of active material for the cathode and the anode.

Then, as a result of various studies in this regard so as to obtain a lithium ion battery of long life, it has been found that the weight ratio (R) of the cathode active material to the anode active material per unit area of each electrode is preferably in a range from 1.3 to 1.7. R of less than 1.3 is not suitable since the battery power density is decreased. On the other hand, when R is more than 1.7, while the battery capacity increases, the life characteristics at a high current density were worsened. Accordingly, R within a range from 1.3 to 1.7 is excellent and desired in view of the power density and the life.

It has been found, as a result of the study on the coating amount of the anode material, that it is necessary to define the coating amount of the anode material in an appropriate range so as to make the life of the lithium ion battery longer. As a result of various studies also in this regard, it has been found that the coating amount of the anode material is preferably within a range from 3.8 to 4.4 mg/cm². When it is less than 3.8 mg/cm², the reaction resistance of the electrode increases since the amount of the anode active materials is insufficient for charge/discharge reaction, and on the other hand, when it is more than 4.4 mg/cm², the diffusion resistance of lithium ions in the anode during charge/discharge reaction increases, which is not preferable.

Further, as a result of investigation of an optimum anode capacity per unit area of the electrode in this case, it has been found that the range is from 0.8 to 1.2 mAh/cm². With the same reason as described above, it is not desired that the capacity of the anode is less than 0.8 mAh/cm² since the amount of the anode active material is small and the reaction resistance of the anode increases and, on the other hand, that the capacity of the anode is more than 1.2 mAh/cm² since the diffusion resistance of lithium ions in the anode increases.

Then, description is to be made for the cathode. The cathode is formed by coating a cathode material on a current collector comprising aluminum. The cathode material has a cathode active material that contributes to intercalation and deintercalation of lithium, a conductive material, a binder, etc.

As the cathode active material, a composite compound of lithium having a crystal structure such as a spinel type cubic system, layered hexagonal system, oribin type orthorhombic system, and triclinic system, etc. and a transition metal is used. With a view point of high power and long life, layered type hexagonal system containing at least lithium and nickel, manganese, and cobalt is preferable and LiₓMnₐNi_{b}Co_{c}M_{d}O₂ is particularly preferable (M is at least one element selected from the group consisting of Fe, V, Ti, Cu, Al, Sn, Zn, Mg, and B and, preferably, Al, B, or Mg) and 0≦a≦0.6, 0.3≦b≦0.7, 0≦c≦0.4, 0≦d≦0.1, a+b+c+d=1.0, and 1.0≦x≦1.1. The cathode active material has an average particle diameter preferably of 10 μm or less.

The cathode active material is obtained in the following manner. Initially, the raw material is obtained by supplying a powder of a predetermined composition ratio of lithium and metal element, pulverizing and mixing the same by a mechanical method, for example, by using a ball mill. The pulverization and mixing may either be a dry or a wet process. The particle size of the pulverized raw material powder is preferably 1 μm or less and, more preferably, 0.3 μm or less. Further, the thus pulverized raw material powder is preferably granulated by spray drying. Then, the thus obtained powder is calcined at 850 to 1100° C., preferably, 900 to 1050° C. Calcining can be performed in an atmosphere of an oxidative gas atmosphere such as oxygen and air, in an inert gas atmosphere such as of nitrogen and argon, or in an atmosphere of mixing them.

As the conductive material, blocky graphite powder or flaky graphite powder with the length Lc in the direction of the c axis of graphite crystal lattice of 100 nm or more and having high conductivity, or an amorphous carbon powder such as carbon black can be used, and they may be used in combination. It is preferably added by 1 to 10% by weight in the case of the blocky graphite powder, 1 to 7% by weight in the case of the flaky graphite powder, and 0.5 to 7% by weight in the case of the amorphous carbon powder. When the blocky graphite is less than 1% by weight, a conduction network in the cathode is insufficient. When it exceeds 10% by weight, the battery capacity is lowered by the decrease in the amount of the cathode active material. When the amount of the flaky graphite powder is less than 1% by weight, the effect of the conductive material is insufficient. When it exceeds 7% by weight, since the average particle size of flaky graphite is large, voids are formed in the cathode causing the decrease of the density of the cathode. When the amount of amorphous carbon is less than 0.5% by weight, it is insufficient to keep electrical connections between the cathode active materials and the amorphous carbon. When it exceeds 7% by weight, it causes remarkable lowering of the electrode density of the cathode due to bulky density of the amorphous carbon.

It has been known that the charge/discharge efficiency is specifically low for both the anode and the cathode at the initial cycle as compared with that at the second and the succeeding cycles. Since the initial efficiency of the anode and the cathode is considered to provide an effect on the charge/discharge operation range of the anode, various studies have been made on them. As a result, assuming the initial charge/discharge efficacies of the anode and the cathode as ηₙ and ηₚ, respectively, it has been found that a battery of long life can be obtained when: ηₙ>ηₚ.

Change of potential of the anode and the cathode in the initial cycle is shown in the case of a relation: ηₙ<ηₚ in FIG. 2A, and a relation: ηₙ>ηₚ in FIG. 2B. In FIGS. 2A and 2B, are shown potential change 21 of the cathode in the initial cycle, potential change 22 of the anode in the initial cycle, charge/discharge operation range 23 for the anode, potential change 24 of the cathode in the initial cycle, potential change 25 of the anode in the initial cycle, and charge/discharge operation range 26 for the anode. Further, the discharge curve is represented as a turned back form relative to the charge curve. When ηₙ<ηₚ, the charge/discharge operation range of the anode is fully used from a low potential to a high potential of anode. On the other hand, in a case: ηₙ>ηₚ, the charge/discharge operation range for the anode is limited to a low potential region of the anode.

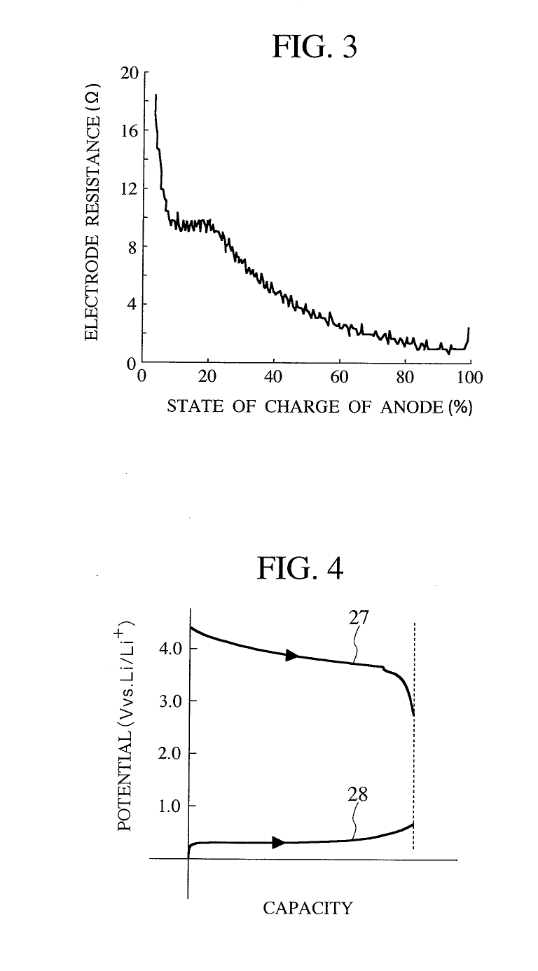

FIG. 3 shows the change of electrode resistance relative to the state of charge (SOC) for the anode. It has been found that the electrode resistance becomes higher at a lower SOC region of the anode where the potential of the anode becomes higher. Based on the result, it is considered that a battery of long life can be obtained, in the case of ηₙ>ηₚ, by avoiding higher resistance region of anode because the charge/discharge operation range for the anode is limited to a low potential region.

As a result of investigation on a relation between the anode potential and the electrode resistance in this case, it has been found that increase of anode resistance is suppressed within an anode potential range from 0 to 0.5 V vs. Li/Li⁺. Accordingly, it can be said that the amount of the anode and the cathode are preferably adjusted such that the discharge end-point potential of the anode in the charge/discharge cycle must be within a range from 0 to 0.5 V vs. Li/Li⁺.

As the cathode active material providing: ηₙ>ηₚ, LiₓMnₐNi_{b}Co_{c}M_{d}O₂ described above is preferable and ranges for 0.1≦a≦0.4, 0.4≦b≦0.7, 0≦c≦0.2, 0≦d≦0.1 are particularly preferable.

Further, also in a case: ηₙ<ηₚ, the charge/discharge efficiency of the cathode can be intentionally decreased by adding an aromatic compound additive to the electrolyte that decomposes at the cathode. Thereby, the charge/discharge operation range of the anode can be intentionally shifted to a lower potential region. Such an aromatic compound includes, for example, cyclohexyl benzene, isopropyl benzene, n-butyl benzene, octyl benzene, toluene, xylene, diphenyl disulfide (C₆H₅—S—S—C₆H₅), phenyl sulfide C₆H₅—S—C₆H₅, phenyldithiane (C₆H₅—C₄S₂H₇), diphenyl thiocarbonate [(C₆H₅S)₂C═O], C₆H₅S—C(O)—OR(R═CH₃, C₂H₅). The amount of the aromatic compound additive to the electrolyte is preferably 1% by weight or more, more preferably, 3% by weight or more and, further preferably, 4% by weight or more. Further, 10% by weight or less is preferable.

As the electrolyte, it is preferable to use those formed by dissolving, for example, lithium hexafluorophosphate (LiPF₆), lithium tetrafluoroborate (LiBF₄), and lithium perchlorate (LiClO₄) as an electrolyte into a solvent such as diethyl carbonate, (DEC), dimethyl carbonate (DMC), ethylene carbonate (EC), propylene carbonate (PC), vinylene carbonate (VC), methyl acetate (MA), ethylmethyl carbonate (EMC), and methyl propyl carbonate (MPC). The concentration of the electrolyte is preferably from 0.7 to 1.5M.

As a method other than the addition of the aromatic compound, graphite having high charge/discharge efficiency in the initial cycle can be mixed with the anode for the anode active material. In the same manner as described above, the charge/discharge operation range of the anode can be intentionally shifted to a lower potential region. As the graphite material, those materials which have inter layer distance (d₀₀₂) being in a range from 0.335 to 0.34 nm are particularly preferable. The mixing amount to the anode is preferably within a range from 10 to 40% by weight. When it is less than 10% by weight, shift of the charge/discharge operation region of the anode is small and insufficient. When it is more than 40% by weight, the degree of electrode expansion/shrinkage during charge/discharge cycle increases, resulting in rather shortening the life of batteries.

Description is to be made with reference to examples, but invention is not restricted to such examples.

### EXAMPLES 1 TO 5

### (Synthesis of Anode Active Material)

Coal type coal tar was heat treated at 400° C. by using an autoclave to obtain raw cokes. After pulverizing the raw cokes, calcining was performed within a range from 900 to 1400° C. in an inert atmosphere to obtain various cokes lumps with an inter layer distance (d₀₀₂) of 0.345 to 0.37 nm and an intrinsic density (ρ) of 1.7 to 2.0 g/cc. The cokes lumps were pulverized by using an impact pulverizer having a classifier and coarse powder was removed by 300 mesh sieve and served for experiment as carbon particles.

### (Synthesis of Cathode Active Material)

Nickel oxide, manganese oxide, and cobalt oxide were used as the starting material, weighed such that Ni:Mn:Co ratio was 1:1:1 by atomic ratio and pulverized and mixed by a wet type pulverizer. Then, the pulverized mixed powder with addition of polyvinyl alcohol (PVA) as a binder was granulated by a spry drier. The obtained granulated powder was placed in a high purity aluminum vessel and provisional calcining was performed at 600° C. for 12 hr for evaporating PVA, and crushed after cooling in air. Further, lithium hydroxide monohydrate was added to the crushed powder such that the atomic ratio of Li: total transition metal (Ni, Mn, Co) was 1.1:1 and mixed sufficiently. The mixed powder was placed in a high purity aluminum vessel and was calcined at 900° C. for 6 hr. The obtained cathode active material was pulverized and classified. The average particle diameter of the cathode active material was 6 μm.

### (Manufacture of Anode)

Using 40% by weight of SBR latex (BM-400B, manufactured by Nippon Zeon Corp.) as a binder, and 1.5% by weight of an aqueous solution of carboxymethyl cellulose (CMC (Dycel 2200, manufactured by Dycel Chemical Industries, Ltd.) as a viscosity improver, SBR and CMC were mixed to the anode active material at a weight ratio of 97:1.5:1.5, sufficiently stirred by a planetary mixer, to prepare an anode slurry. An anode slurry was coated on a copper foil of 10 μm thickness by using a coater having various coating amounts. After drying the anode slurry, the coated anode was roll-pressed.

### (Manufacture of Cathode)

By using a cathode active material, blocky graphite powder, flaky graphite powder, and amorphous graphite as a conductive material, and polyvinylidene fluoride dissolved in N-Methyl-2-pyrrolidone as a binder material (PVDF (KF#1120, manufactured by Kureha Corp.), they were mixed such that the respective weight ratio was 85:7:2:2:4. Further, they were stirred sufficiently by a planetary mixer to prepare a cathode slurry. The cathode slurry was coated on an aluminum coil of 20 μm thickness by using a coater having various coating amounts. After drying the cathode slurry, the coated cathode was roll-pressed.

### (Manufacture of Lithium Ion Battery)

A cathode sheet and an anode sheet were cut each into a predetermined size, and current collector tabs were attached by supersonic welding to non-coated portions on both ends of the electrode respectively. The cathode current collector tab was made of aluminum and the anode current collector tab was made of nickel. Using the cathode and the anode, the cathode and the anode were combined such that the weight ratio (R) of the cathode active material to the anode active material was within a range from 1.3 to 1.7. Then, a porous polyethylene film was sandwiched between the cathode and the anode and wound into a cylindrical shape. The wound body was inserted to a battery casing, the anode tab was connected to the bottom of-the battery casing by resistance welding and, on the other hand, a cathode tab was connected to the inner side of a lid by supersonic welding. An electrolyte formed by dissolving LiPF₆ by 1.0 mol/L into a mixed solvent of ethylene carbonate (EC) and dimethyl carbonate (DMC) at a volumic ratio of 1:2 was poured and, thereafter, a lid was caulked to the battery casing for sealing, to obtain lithium ion batteries as shown in Table 1.

TABLE 1

| | | | Cathode active | | |
|---|---|---|---|---|---|
| | | | material/anode | | Battery |
| | | | active | Battery | resistance |
| | Anode | | material | power | increase |
| | d₀₀₂ | Anode ρ | weight ratio | density | ratio |
| | (nm) | (g/cc) | R (—) | (W/kg) | (%) |
| Example 1 | 0.345 | 2.1 | 1.3 | 2120 | 118 |
| Example 2 | 0.36 | 1.8 | 1.3 | 2140 | 119 |
| Example 3 | 0.37 | 1.7 | 1.3 | 2130 | 117 |
| Example 4 | 0.36 | 1.8 | 1.5 | 2120 | 116 |
| Example 5 | 0.36 | 1.8 | 1.7 | 2150 | 119 |
| Comparative | 0.34 | 2.2 | 1.3 | 2140 | 153 |
| Example 1 | | | | | |
| Comparative | 0.38 | 1.6 | 1.3 | 1520 | 117 |
| Example 2 | | | | | |
| Comparative | 0.38 | 1.6 | 1.7 | 1740 | 116 |
| Example 3 | | | | | |
| Comparative | 0.36 | 1.8 | 1.2 | 1650 | 118 |
| Example 4 | | | | | |
| Comparative | 0.36 | 1.8 | 1.8 | 2120 | 142 |
| Example 5 | | | | | |

### (Continuous Charge/Discharge Pulse Test)

Using the lithium secondary batteries describe above, a continuous charge/discharge pulse test was performed under the following conditions.
(1) Central voltage of battery for charge/discharge pulse: 3.6 V
(2) Discharge pulse: Current 12CA (0.083 hour rate current), time for 30 sec
(3) Charge pulse: Current 6CA (0.167 hour rate current), time for 15 sec
(4) Rest time between charge and discharge pulse: 30 sec
(5) Since the central voltage fluctuates, constant voltage charge or constant voltage discharge is performed at 3.6 V every 1000 pulses to keep the central voltage.
(6) Ambient surrounding temperature: 50° C.

Further, the DC resistance and the power density of the battery were determined by the following method. Under the circumstance at 50° C., discharge was performed for 10 sec in the order of current of 4CA, 8CA, 12CA, and 16CA. The relation between the discharge current and the voltage at 10 sec in this case was plotted to determine the DC. resistance based on the slant of the obtained linear curve. Further, the current value at 2.5 V on the linear curve was determined, and the product value of 2.5 V and the above current was divided by the weight of the battery to determine the power density. Table 1 shows the initial power density and the resistance increasing ratio after 50000 pulse cycles (assuming the initial resistance as 100).

### COMPARATIVE EXAMPLES 1

In the synthesis of the anode active materials in Examples 1 to 5, the calcining temperature was increased to 2200° C., to obtain a carbon material with d₀₀₂ of 0.34 nm. Then, a lithium ion battery was obtained in the same manner as in Examples 1 to 5.

### COMPARATIVE EXAMPLES 2 and 3

In the synthesis of the anode active materials in Examples 1 to 5, the calcining temperature was lowered to 800° C., to obtain a carbon material with d₀₀₂ of 0.38 nm. Then, lithium ion batteries were obtained in the same manner as in Examples 1 to 5.

### COMPARATIVE EXAMPLE 4

In Examples 1 to 5, the cathode and the anode were combined such that the weight ratio (R) of the cathode active material to the anode active material was 1.2. Then, a lithium ion battery was obtained in the same manner as in Examples 1 to 5.

### COMPARATIVE EXAMPLE 5

In Examples 1 to 5, the cathode and the anode were combined such that the weight ratio (R) of the cathode active material to the anode active material was 1.8. Then, a lithium ion battery was obtained in the same manner as in Examples 1 to 5.

In the same manner as in Example 1 to 5, the continuous charge/discharge pulse test was performed on the batteries of Comparative Examples 1 to 5 to determine the DC resistance and the power density. Table 1 shows the initial power density and the resistance increasing ratio after 50000 pulse cycles (assuming the initial resistance as 100).

As shown in Table 1, it was found that the lithium ion batteries of Examples 1 to 5 with d₀₀₂ of from 0.345 to 0.37 nm, ρ of 1.7 to 2.1 g/cc, and R of 1.3 to 1.7 had higher power density of the battery, lower resistance increasing ratio of the battery, and longer life as compared with those of Comparative Examples 1 to 5.

### EXAMPLES 6 TO 10

Using the carbon material with d₀₀₂ of 0.345 nm, and p of 2.1 g/cc manufactured in Examples 1 to 5 as the anode active material, anodes were manufactured while changing the coating amount of the active material in a range from 3.4 to 4.8 mg/cm². The cathode and the anode were combined such that the weight ratio (R) between the cathode active material and the anode active material was 1.5. Then, lithium ion batteries were obtained in the same manner as in Examples 1 to 5.

In the same manner as in Example 1 to 5, the continuous charge/discharge pulse test was performed on the batteries of Examples 6 to 10 to determine the DC resistance and the power density. Table 2 shows the initial power density and the resistance increasing ratio after 50000 pulse cycles (assuming the initial resistance as 100).

### COMPARATIVE EXAMPLE 6

Using the carbon material with d₀₀₂ of 0.38 nm, and ρ of 1.6 g/cc manufactured in Comparative Example 2 as the anode active material, an anode with the coating amount of the active material of 3.4 mg/cm² was manufactured. The cathode and the anode were combined such that the weight ratio (R) of the cathode active material to the anode active material was 1.5. Then, a lithium ion battery was obtained in the same manner as in Examples 1 to 5.

### COMPARATIVE EXAMPLE 7

Using the carbon material with d₀₀₂ of 0.38 nm, and ρ of 1.6 g/cc manufactured in Comparative Example 2 as the anode active material, an anode was manufactured with the coating amount of the active material of 4.8 mg/cm². The cathode and the anode were combined such that the weight ratio (R) of the cathode active material to the anode active material was 1.5. Then, lithium ion battery was obtained in the same manner as in Examples 1 to 5.

In the same manner as in Example 1 to 5, the continuous charge/discharge pulse test was performed on the batteries of Examples 6, 7 to determine the DC resistance and the power density. Table 2 shows the initial power density and the resistance increasing ratio after 50000 pulse cycles (assuming the initial resistance as 100).

TABLE 2

| | | | | Anode | | |
|---|---|---|---|---|---|---|
| | | | Cathode active | active | | Battery |
| | | | material/anode | material | Battery | resistance |
| | | | active material | coating | power | increasing |
| | Anode d₀₀₂ | Anode ρ | weight ratio | amount | density | ratio |
| | (nm) | (g/cc) | R (—) | (mg/cm²) | (W/kg) | (%) |
| Example 6 | 0.345 | 2.1 | 1.5 | 3.4 | 2120 | 116 |
| Example 7 | 0.345 | 2.1 | 1.5 | 3.8 | 2240 | 117 |
| Example 8 | 0.345 | 2.1 | 1.5 | 4.0 | 2270 | 115 |
| Example 9 | 0.345 | 2.1 | 1.5 | 4.4 | 2230 | 117 |
| Example 10 | 0.345 | 2.1 | 1.5 | 4.8 | 2130 | 118 |
| Comparative | 0.38 | 1.6 | 1.5 | 3.4 | 1480 | 120 |
| Example 6 | | | | | | |
| Comparative | 0.38 | 1.6 | 1.5 | 4.8 | 1510 | 121 |
| Example 7 | | | | | | |

As shown in Table 2, it was found that the lithium ion batteries of Examples 6 to 10 had higher power density of batteries as compared with that of Comparative Examples 6, 7. Further, it was found that the power density of the battery was improved within a range of the coating amount for the anode active material of from 3.8 to 4.4 mg/cm² and the above range was preferable.

### EXAMPLES 11 to 15

Anodes were manufactured by using the anode material with d₀₀₂ of 0.37 nm and ρ of 1.7 g/cc manufactured in Examples 1 to 5 as the anode active material while changing the coating amount such that the anode capacity was within a range from 0.6 to 1.5 mAh/cm². The cathode and the anode were combined such that the weight ratio (R) of the cathode active material to the anode active material was 1.6. Then, lithium ion batteries were obtained in the same manner as in Examples 1 to 5.

In the same manner as in Examples 1 to 5, the continuous charge/discharge pulse test was performed on the batteries of Examples 11 to 15 to determine the DC resistance and the power density. Table 3 shows the initial power density and the resistance increasing ratio after 50000 pulse cycles (assuming the initial resistance as 100).

### COMPARATIVE EXAMPLE 8

An anode having the anode capacity of 0.6 mAh/cm² was manufactured by using the carbon material with d₀₀₂ of 0.34 nm and ρ of 2.2 g/cc manufactured in Comparative Example 1 for the anode active material. The cathode and the anode were combined such that the weight ratio (R) of the cathode active material to the anode active material was 1.6. Then, a lithium ion battery was obtained in the same manner as in Examples 1 to 5.

### COMPARATIVE EXAMPLE 9

An anode with the anode capacity of 1.5 mAh/cm² was manufactured by using the carbon material with d₀₀₂ of 0.34 nm and ρ of 2.2 g/cc manufactured in Comparative Example 1 as the anode active material. The cathode and the anode were combined such that the weight ratio (R) of the cathode active material to the anode active material was 1.6. Then, a lithium ion battery was obtained in the same manner as in Examples 1 to 5.

In the same manner as in Examples 1 to 5, the continuous charge/discharge pulse test was performed on the batteries of Comparative Examples 8, 9 to determine the DC resistance and the power density. Table 3 shows the initial power density and the resistance increasing ratio, after 50000 pulse cycles (assuming the initial resistance as 100).

TABLE 3

| | | | Cathode active | | | |
|---|---|---|---|---|---|---|
| | | | material/anode | | | Battery |
| | | | active | | Battery | resistance |
| | Anode | | material | Anode | power | increasing |
| | D₀₀₂ | Anode ρ | weight ratio | capacity | density | ratio |
| | (nm) | (g/cc) | R (—) | (mAh/cm²) | (W/kg) | (%) |
| Example 11 | 0.37 | 1.7 | 1.6 | 0.6 | 2010 | 116 |
| Example 12 | 0.37 | 1.7 | 1.6 | 0.8 | 2160 | 117 |
| Example 13 | 0.37 | 1.7 | 1.6 | 1.0 | 2180 | 115 |
| Example 14 | 0.37 | 1.7 | 1.6 | 1.2 | 2200 | 117 |
| Example 15 | 0.37 | 1.7 | 1.6 | 1.5 | 2060 | 118 |
| Comparative | 0.34 | 2.2 | 1.6 | 0.6 | 1630 | 148 |
| Example 8 | | | | | | |
| Comparative | 0.34 | 2.2 | 1.6 | 1.5 | 1650 | 162 |
| Example 9 | | | | | | |

As shown in Table 3, it was found that the lithium ion batteries of Examples 11 to 15 had higher power density of batteries as compared with that of Comparative Examples 8, 9. Further, it was found that the power density of the battery was improved within a range of the anode capacity of from 0.8 to 1.2 mAh/cm² and the above range was preferable.

### EXAMPLES 16, 17

### (Measurement for Initial Efficiency of the Cathode and the Anode)

In the synthesis of the cathode active materials for Examples 1 to 5, nickel oxide, manganese oxide, and cobalt oxide were used as the starting material and they were weighed such that Ni:Mn:Co ratio was 3:1:1 by atomic ratio to manufacture cathode active materials in the same manner as in Examples 1 to 5.

Initial charge/discharge efficiencies of the cathodes of Examples 1 to 5, the cathode described above, and the carbon anode with d₀₀₂ of 0.345 nm and p of 2.1 g/cc were examined by an electrochemical cell using lithium metal for a reference electrode and a counter electrode. LiPF₆ dissolved by 1.0 mol/L in a mixed solvent of ethylene carbonate (EC) and dimethyl carbonate (DMC) at 1.2 volumic ratio was used as the electrolyte. Charge for the cathode was performed at a constant current density of 0.5 mA/cm² up to 4.3 V. Discharge for the cathode was performed at a constant current density of 0.5 mA/cm² to 3.0 V. On the other hand, charge for the anode was performed at a constant current density of 0.5 mA/cm² to 0.005 V. Discharge for the anode was performed at a constant current density of 0.5 mA/cm² up to 2.0 V. The directions of current at the cathode and the anode were just opposite to each other in a single electrode evaluation, and the potential of the anode decreases during charge.

When the initial charge/discharge efficiencies for the cathodes of Examples 1 to 5, the cathode of Example 16, and the carbon anode with d₀₀₂ of 0.345 nm and ρ of 2.1 g/cc were determined by the above described manner, they were 87%, 75%, and 82%, respectively.

A battery for: ηₙ<ηₚ and a battery for: η_{n>η}ₚ were manufactured in the same manner as in Examples 1 to 5 by using the cathodes and the anodes described above. In the same manner as in Examples 1 to 5, continuous charge/discharge pulse test was performed on the batteries of Examples 16 and 17 to determine the DC resistance and the power density. Table 4 shows the initial power density and the resistance increasing ratio after 50000 pulse cycles (assuming initial resistance as 100).

TABLE 4

| | | | | | | Battery |
|---|---|---|---|---|---|---|
| | | Cathode | Anode | | Battery | resistance |
| | | initial | initial | Relation | power | increasing |
| | | efficiency | efficiency | for | density | ratio |
| | Cathode composition | ηₚ (%) | ηₙ (%) | efficiency | (W/kg) | (%) |
| Example 16 | LiNi_{0.33}Mn_{0.33}Co_{0.33}O₂ | 87 | 82 | ηₙ < ηₚ | 2110 | 118 |
| Example 17 | LiNi_{0.6}Mn_{0.2}Co_{0.2}O₂ | 75 | 82 | ηₙ > ηₚ | 2250 | 110 |

As shown in Table 4, it was found that since Example 17 had higher power density of the battery and the smaller resistance increasing ratio of the battery as compared with Example 16, it is preferable that ηₙ>ηₚ. Because the charge/discharge operation range of the anode is limited in a lower potential region where the resistance of the anode does not increase in a case: ηₙ>ηₚ.

### EXAMPLE 18

After manufacturing a lithium ion battery in the same manner as in Examples 1 to 5 by using an electrolyte with addition of phenyl sulfide of 3% by weight to the battery of Example 1, a continuous charge/discharge pulse test was performed to determine the DC resistance and the power density. Since the initial power density was 2200 W/kg, the resistance increasing ratio after 50000 pulse cycles (assuming the initial resistance as 100) was 112%, and the resistance increasing ratio of the battery was smaller along with the increase in the power density of the battery, it is preferable to add the aromatic additives.

### EXAMPLE 19

In the synthesis of the cathode active materials of Examples 1 to 5, nickel oxide, manganese oxide and cobalt oxide were used as the starting material and they were weighed such that Ni:Mn:Co ratio was 7:1:2 by atomic ratio to manufacture a cathode active material in the same manner as in Examples 1 to 5.

Lithium ion battery was manufactured by using the cathode as described above and the carbon anode with d₀₀₂ of 0.345 nm and ρ of 2.1 g/cc in the same manner as in Examples 1 to 5. After 5 charge/discharge cycles between 4.2 V and 2.7 V for the battery of Example 19, the battery was disassembled in a glove box of an argon atmosphere to take out a wound body. In a state of dipping the wound body in an electrolyte, each of the potentials on the cathode and the anode was measured by using a beaker type electrochemical cell and using lithium metal as a reference electrode. LiPF₆ dissolved by 1.0 mol/L in a mixed solvent of ethylene carbonate (EC) and dimethyl carbonate (DMC) at a volumic ratio of 1:2 was used as the electrolyte.

FIG. 4 shows the change of each potential on the cathode and the anode of the disassembled battery of Example 19. It was shown that the potential on the cathode was 3.1 V and the potential on the anode was 0.4 V at the end-point of discharge. Assuming the initial charge/discharge efficiency for the cathode and the anode as ηₙ, and ηₚ, respectively, it is considered that ηₙ>ηₚ, because the change of the cathode and the anode in FIG. 4 is similar to that in FIG. 2B.

In the same manner as in Examples 1 to 5, the continuous charge/discharge pulse test was performed on the other battery of Example 19 to determine the DC resistance and the power density. The initial power density was 2300 W/kg, and the resistance increasing ratio after 50000 pulse cycles (assuming the initial resistance as 100) was 113%, which showed excellent battery characteristics of particularly high power density. This is considered to be attributable to that the anode potential upon discharge end-point is limited within a range from 0 to 0.5 V vs. Li/Li⁺ and the resistance increasing ratio of the anode is smaller as shown in FIG. 3 in the battery of the Example 19.

### EXAMPLES 20 TO 24

In Example 4, graphite with d₀₀₂ of 0.336 was added within a range from 5 to 50% by weight to the anode. Then, lithium ion batteries were obtained in the same manner as in Examples 1 to 5.

In the same manner as in Examples 1 to 5, the continuous charge/discharge pulse test was performed on the batteries of Comparative Examples 20 to 24 to determine the DC resistance and the power density. Table 5 shows the initial power density and the resistance increasing ratio after 50000 pulse cycles (assuming the initial resistance as 100).

TABLE 5

| | | | Cathode active | | | |
|---|---|---|---|---|---|---|
| | | | material/anode | | | Battery |
| | | | active | Graphite | Battery | resistance |
| | | | material | mixing | power | increase |
| | Anode d₀₀₂ | Anode ρ | weight ratio | amount | density | ratio |
| | (nm) | (g/cc) | R (—) | (%) | (W/kg) | (%) |
| Example | 0.36 | 1.8 | 1.5 | 5 | 2110 | 116 |
| 20 | | | | | | |
| Example | 0.36 | 1.8 | 1.5 | 10 | 2200 | 115 |
| 21 | | | | | | |
| Example | 0.36 | 1.8 | 1.5 | 25 | 2240 | 115 |
| 22 | | | | | | |
| Example | 0.36 | 1.8 | 1.5 | 40 | 2240 | 117 |
| 23 | | | | | | |
| Example | 0.36 | 1.8 | 1.5 | 50 | 2260 | 128 |
| 24 | | | | | | |

As shown in Table 5, when graphite was added by 10 to 40% by weight, the battery power density was increased. Increase in the power density was small when it was less than 10% by weight and life was shortened when it was more than 40% by weight.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A lithium ion secondary battery in which a cathode for intercalating and deintercalating lithium ions, and an anode for intercalating and deintercalating lithium ions are formed by way of an electrolyte and a separator,
the cathode having a cathode active material,
the anode having an anode active material and a binder, the anode active material containing at least a carbon material,
wherein the binder comprises a styrene-butadiene copolymer rubber latex and a cellulosic viscosity improver, the carbon material has an inter layer distance d₀₀₂ of 0.345 nm or more and 0.370 nm or less and an intrinsic viscosity ρ of 1.7 g/cc or more and 2.1 g/cc or less, and the weight ratio for the amount of the cathode active material per unit area contained in the cathode to the amount of the anode active material per unit area contained in the anode is 1.3 or more and 1.7 or less.

2. The lithium ion secondary battery according to claim 1, wherein the amount of the anode active material per unit area on one surface of the anode is 3.8 mg/cm² or more and 4.4 mg/cm² or less.

3. The lithium ion secondary battery according to claim 1, wherein the capacity of the anode per unit area on one surface of the anode is 0.8 mAh/cm² or more and 1.2 mAg/cm² or less.

4. The lithium ion secondary battery according to claim 1, wherein the initial charge/discharge efficiency ηₙ of the anode and the initial charge/discharge efficiency ηₚ of the cathode is: ηₙ>ηₚ.

5. The lithium ion secondary battery according to claim 1, wherein the electrolyte contains an aromatic compound.

6. The lithium ion secondary battery according to claim 1, wherein the discharge end-point potential of the anode in the charge/discharge cycle is 0.5 V vs. Li/Li⁺ or less.

7. The lithium ion secondary battery according to claim 1, wherein the anode contains from 10 to 40% by weight of graphite with d₀₀₂ of 0.335 nm or more and 0.34 nm or less.

8. The lithium ion secondary battery according to claim 1, wherein the cathode active material is LiₓMnₐNi_{b}Co_{c}M_{d}O₂ (0.1≦a≦0.4, 0.4≦b≦0.7, 0≦c≦0.2, 0≦d≦0.1, a+b+c+d=1, 1.0≦x≦1.1).
